(19) United States
(12) Patent Application Publication
(10) Pub. No.: US 2004/0092616 A1
(43) Pub. Date: May 13, 2004

(54) Process for producing rigid polyurethane foams and finished articles obtained therefrom

(76) Inventors: Ernesto Occhiello, Lake Jackson, TX (US); Paolo Golini, Turbigo (IT)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/416,277

(22) PCT Filed: Nov. 9, 2001
(86) PCT No.: PCT/EP01/13011

(30) Foreign Application Priority Data
Nov. 9, 2000 (IT) MI2000A002418

(51) Int. Cl. C08G 18/00

(52) U.S. Cl. 521/161; 521/170

(57) ABSTRACT

A process for producing a low-density rigid polyurethane foam by reacting a polyisocyanate and a polyol composition which comprises a hydroxy-terminal polyfunctional polyol component using an expansion system comprising water, liquid CO₂ and optionally a hydrofluorocarbon auxiliary expander. The water is present in an amount of less than 1 par by weight per 100 parts of polyol component. The polyurethane foam may be used in the manufacture of heat insulating panels.

This invention relates to a process for producing a rigid polyurethane foam and to a finished article obtained from the foam.

More particularly, the invention relates to a process for producing a low-density rigid polyurethane foam obtained in the absence of a secondary expander of chlorofluoroalkane type, and to a finished article obtained from the foam.

Even more particularly, the invention relates to a process for producing a heat-insulating panel comprising a low-density rigid polyurethane foam obtained in the absence of a secondary expander of the chlorofluoroalkane type, the foam having high performance qualities as regards fire resistance.

Processes for preparing low-density rigid polyurethane foams obtained in the absence of secondary expanding agents of the chlorofluoroalkane type, the use of which is regulated by the Montreal Protocol due to perceived harmful effects on the ozone layer of the stratosphere.

Thus, for example, U.S. Pat. No. 5,096,933 describes a process for preparing rigid polyurethane foams with a density of between 20 and 50 g/l, which involves reacting an organic polyisocyanate with a polyol, chosen from polyether or polyester polyols with a functionality of between 2 and 8 and a hydroxyl number of between 150 and 850. A mixture of water in an amount of up to 7 parts per 100 parts by weight of polyol, and a hydrocarbon selected from cyclopentane, cyclohexane or mixtures thereof, in an amount of between 3 and 22 parts is employed as the expander.

EP-A-394769 describes a process for preparing rigid polyurethane foams with heat-insulating capacity, by reacting the conventional reagents in the presence of an expander consisting of an alkyl hydrocarbon containing from 3 to 6 carbon atoms with a boiling point at atmospheric pressure of between −10° C. and +70° C.

The expanded rigid polyurethane materials obtained in the presence of expanders of the hydrocarbon type have the drawback of containing a highly flammable gas which lowers the fire resistance properties thereof.

Satisfactory fire resistance is an important characteristic in certain applications for example, the building industry, in which these materials need to meet very strict standards.

One approach to improve fire resistance involves increasing the amount of flame retardant used in the formulation to produce the foams. However, although this solution ameliorates the problem of the resistance to fire, it may introduce drawbacks since increasing the concentration of flame retardants may have the consequence of reducing the physicomechanical performance qualities of the finished product, thus making it unsuitable for the intended uses.

The Applicant has now found an expanding system for rigid polyurethane foams, based on liquid CO₂, which is capable of producing products with good thermal insulation properties, suitable physicomechanical characteristics and with good fire resistance capable of satisfying DIN standard 4102 category B2, without the need to use excessive amounts of flame retardants.

Thus, one aspect of the present invention is a process for producing a low-density rigid polyurethane foam which comprises reacting a polyisocyanate with a polyol composition which comprises a hydroxy-terminal polyfunctional polyol component in the presence of an expansion system comprising, and preferably consisting essentially of, water, liquid CO₂ and optionally a hydrofluorocarbon auxiliary expander having from 1 to 6 carbon atoms, and in which the water is present in an amount of less than 1 part by weight per 100 parts of polyol component.

Preferably the polyisocyanate and polyol component are present at such a level as to provide an NCO/OH ratio from 1.3 to 3.

According to the present invention, any organic polyisocyanate may be used to prepare the present polyurethane foams, although aromatic or cycloaliphatic polyisocyanates and the corresponding alkyl-substituted derivatives are preferred.

In particular, a low molecular weight diisocyanate of general formula (I) may be employed:

OCN—R—NCO (I)

in which R represents a C₅ to C₂₅ cycloaliphatic or C₆ to C₁₈ aromatic radical, optionally substituted in either case with a C₁ to C₄ alkyl radical, for instance meta-phenylene diisocyanate, para-phenylene diisocyanate, 2,4-toluene diisocyanate either alone or mixed with the 2,6-toluene diisocyanate isomer, 4,4′-diphenylmethane diisocyanate, optionally mixed with the 2,4′-isomer, 4,4′-dicyclohexylmethane diisocyanate, and 1-isocyanate-3-isocyanatomethyl-3,3,5-trimethylcyclohexane.

Medium or high molecular weight polyisocyanates with various degrees of condensation may be employed. Such polyisocyanates are suitably obtained by the phosgenation of an aniline-formaldehyde condensate. These products may comprise one or typically a mixture of compounds of general formula (II):

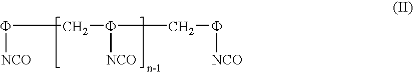

in which Φ represents a phenyl group and n is an integer greater than or equal to 1, for example copolymethylenepolyphenyl polyisocyanates.

Medium or high molecular weight polyisocyanates that are preferred include polymethylenepolyphenyl polyisocynates (MDI polymer) with an average functionality of between 2.6 and 2.9. Such products are commercially available under various names such as “Tedimon 31” (Enichem S.p.A.), “Suprasec DNR” or Desmodur 44 V20 (Bayer).

Further examples of suitable polyisocyanates include the “multivalent modified isocyanates” obtained by the partial chemical reaction of a diisocyanate and/or a polyisocyanate (isocyanates). Specific examples comprise isocyanates containing biuret groups, allophanate groups, carbodiimide groups, isocyanurate groups and/or urethane groups. In particular, isocyanic prepolymers with an isocyanic functionality of between 15% and 33% by weight, obtained by reacting an excess of equivalents of one or more isocyanates of general formlula (I) or (II) with at least one polyol with a molecular weight of less than 1500 are preferred.

The isocyanic component may also comprise a mixture of the polyisocyanates mentioned above.

Suitably, the polyol component comprises at least one polyol with a functionality from 2 to 8 and an equivalent weight of 50 to 500. Suitably, the polyol is selected from polyether polyols, polyether polyols containing ester groups, polyether polyols containing amine groups and polyester polyols.

Preferred polyols include polyether polyols obtained by condensing a C₂ to C₆ olefinic oxide with a compound (starters) containing at least two active hydrogen atoms. Preferred olefinic oxides are ethylene oxide; propylene oxide or mixtures thereof. Suitable starters include glycols, triols, tetrols, amines, alkanolamines, polyamines and mixtures thereof.

Examples of suitable polyether polyols include those with propylene oxide and/or ethylene oxide groups reacted with a starter compound selected from a glycol such as diethylene glycol or dipropylene glycol; a diamine such as ortho-toluenediamine; a triol such as glycerol; a tetrol such as pentaerythritol; or a polyfunctional hydroxyalkane such as xylitol, arabitol, sorbitol and mannitol.

These polyols may be used in unmodified form or may contain, in dispersion or partially grafted to the polyol chains, solid particles with a flame-retardant function, for example melamine, or polymeric fillers with a reinforcing function. Any such fillers or solid particles suitably are smaller than 20 micrometres. Polymers are preferred as the solid particles or polymeric fillers and suitable polymers for this purpose include: polyacrylonitrile, polystyrene, polyvinyl chloride and mixtures or copolymers thereof, or urea-based polymers. The said polymer particles may be prepared by in situ polymerization in the polyol or may be prepared separately and added to the polyol in a second stage.

Further polyols that are preferred include polyester polyols, which may be used alone or mixed with a polyether polyol, for example as mentioned above. The polyester polyols may suitably be obtained by the polycondensation of at least one dicarboxylic organic acid containing from 2 to 12 carbon atoms and preferably from 4 to 6 carbon atoms, with at least one polyfunctional alcohol, for example with 2 to 6 functional groups, containing from 2 to 12 carbon atoms and desirably from 2 to 6 carbon atoms.

Suitably, the polycondensation reaction is carried out at a temperature of between 150 and 250° C., optionally at a pressure below atmospheric pressure, in the presence or absence of an esterification catalyst, desirably selected from iron, cadmium, cobalt, lead, zinc, antimony.

Examples of suitable dicarboxylic acids include: succinic acid, glutaric acid, adipic acid, suberic acid, azelaic acid, sebacic acid, maleic acid, fumaric acid, isophthalic acid, terephthalic acid and decanedicarboxylic acid.

Examples of suitable polyfunctional alcohols include: ethanediol, diethylene glycol, 1,2- and 1,3-propanediol, dipropylene glycol, 1,4-butanediol, 1,5-pentanediol, 1,10-decanediol, glycerol and trimethylolpropane.

In a preferred embodiment of the invention, the polyol is suitably selected from diethylene glycol, dipropylene glycol, 1,4-butanediol, glycerol, trimethylolpropane and polyols of ethylene oxide and/or propylene oxide.

Suitably, the polyol composition also comprises one or more additives commonly used for preparing rigid polyurethane foams, such as an amine catalyst, for instance triethylenediamine, and/or a metallic catalyst, for instance stannous octoate, a cell regulator, a thermal-oxidation stabilizer, a pigment and the like.

Details regarding the polymerization of polyurethanes are described in the text “Sanders & Frisch-Polyurethanes, Chemistry and Technology” Interscience, New York, 1964. Preferably, a rigid polyurethane foam obtained by the present process is supplemented with a flame retardant of organic or inorganic nature, for example with melamine, with a phosphorus-based product, for instance ammonium polyphosphate, triethyl phosphate or diethyl ethylphosphonate, with an organophosphorus compound containing a halogen, for instance tris(2-chloroisopropyl) phosphate, or with a brominated polyester, for example, polyesters derived from tetrabromophthalic anhydride.

In general, in the production of polyurethane foams, the presence of water, which acts as one of the components of the expansion system, has a critical function since it is by means of the water that the carbon dioxide, produced in situ, is generated, which brings about the process of expansion of the polyurethane resin.

In the present process, however, the presence of water is reduced to a very small amount, generally less than 1 part by weight per 100 parts of polyol component and preferably less than 0.5 part by weight.

The reaction between water and the NCO groups along with the carbon dioxide may give products with a polyurea matrix, which are detrimental to certain physicomechanical characteristics of the expanded product and have a negative effect on its processability. Employing a small amount of water provides rigid foams of optimum quality. The liquid CO₂ is suitably present in an amount of 0.5% to 3% by weight relative to the said polyol component. Suitably, the CO₂ is introduced by being diluted in the polyol component suitably at a pressure above atmospheric pressure.

Thus, according to the present invention, carbon dioxide generated in situ by the chemical reaction between water and the NCO groups of the polyisocyanate may contribute to expanding the polyurethane resin but the CO₂ obtained by vaporization of the liquid CO₂ is used as the primary agent to expand the polyurethane resin.

Optionally, the expansion system comprises a hydrofluorocarbon as well as a small amount of water and liquid CO₂. The hydrofluorocarbon auxiliary expander is used as secondary agent. The hydrofluorocarbon is preferably selected from 1,1,1,2-tetrafluoroethane (HFC 134a), 1,1,2,2-tetrafluoroethane (HFC 134), 1,1-difluoroethane, pentafluoroethane, 1,1,1,3,3-pentafluoropropane, 1,1,1,3,3-pentafluoro-butane and mixtures thereof. The HFC auxiliary expander is suitably present in an amount of 2.5% to 5% by weight relative to the polyol component. The preferred HFC is 1,1,1,2-tetrafluoroethane. If present, the hydrofluorocarbon auxiliary expander desirably is present in a weight ratio with the CO₂ of 1 to 10.

In one embodiment of the invention, the expansion system comprises water, liquid CO₂ and a hydrofluorocarbon auxiliary expander having from 1 to 6 carbon atoms, in which the water is present in an amount of less than 1 part by weight per 100 parts of polyol component, CO₂ is present at a level of 0.5% to 3% by weight relative to the said polyol component and the hydrofluorocarbon auxiliary expander is present in a weight ratio with the CO₂ of 1 to 10.

Whilst hydrofluorocarbon compounds have been employed in expansion systems to replace chlorine containing fluorocarbons in view of concerns over the destruction of atmospheric ozone, at least some hydrofluorocarbons are believed to act as so-called “greenhouse gases” which in itself is considered to be environmentally undesirable.

In a further embodiment of the invention, the expansion system comprises water and liquid CO₂ in which the water is present in an amount of less than 1 part by weight per 100 parts of polyol component, CO₂ is present at a level of 0.5% to 3% by weight relative to the said polyol component and the expansion system is substantially free of hydrofluorocarbon compounds.

As desired the expansion system may contain other known components to provide an expansion function, for example a hydrocarbon selected from cyclopentane, cyclohexane or mixtures thereof.

In a second aspect, the invention provides a process for producing a heat-insulating panel comprising a low-density rigid polyurethane obtainable by, and preferably obtained by a process according to the first aspect of the invention.

The rigid polyurethane foam obtainable by and preferably obtained by the process of the present invention suitably has a density of between 30 and 45 kg/m³, satisfactory dimensional stability and fire resistance properties which allow a low level of flame retardants to be reduced, preferably to a level of less than 25% for example to 10 to 25% by weight relative to the polyol component. By virtue of these characteristics, the foams of the present invention may find a suitable use in the building sector, which requires materials of the above mentioned properties.

In particular, the rigid polyurethane foams of the present invention may be used for preparing heat-insulating panels for civil and industrial buildings.

In another aspect, the invention provides a heat-insulating panel comprising low-density rigid polyurethane foam obtainable by, and preferably obtained by a process according to the second aspect of the invention and having a surface area of greater than one square meter and a thickness of between 2 and 20 cm.

A number of illustrative and non-limiting examples are given below for the purpose of better comprehension of the present invention and to implement it.

### EXAMPLE 1

100 parts of a formulated polyol containing 54% by weight, relative to the total weight, of a terephthalic acid polyester (Glendion 9801 from Enichem S.p.A.) and 13% by weight of a polyether polyol based on ethylene oxide and propylene oxide derived from ortho-toluenediamine (Tercarol 5902 from Enichem S.p.A.) were mixed with an expanding system consisting of 0.4% by weight of water, 2.5% by weight of liquid CO₂ and 5% by weight of HFC 134a.

The catalytic system, consisting of an amine catalyst (0.41% of dimethyl-cyclohexylamine), 0.72% by weight of potassium acetate (Atecat 9 from Athena) and 0.9% of potassium octoate (Dabco K 15 from Air Products), 0.07% of a cell stabilizer α-methylstyrene), 2% by weight of a silicone surfactant (Tego B8469 from Goldschmidt) and 21% by weight of tris(2-chloroisopropyl) phosphate, were then added.

The polyol composition thus obtained was fed continuously into a mixing head at a temperature of 20° C. and at a pressure of 200 bar where it reacted with MDI polymer of functionality 2.7 (Tedimon 31 from Enichem S.p.A.), fed in at 20° C. and 180 bar, with an NCO/OH ratio equal to 2.4.

The expanded product formed was immediately spread onto Kraft paper on a conveyor belt with an adjustable travelling speed kept constant at 4 m/min, with a distance between the bottom level and the top level of 110 mm.

The panels obtained, of excellent appearance, had the characteristics given in Table 1.

### EXAMPLE 2

The polyol composition of Example 1 was fed continuously into a mixing head at a temperature of 20° C. and at a pressure of 150 bar, where it reacted with MDI polymer of functionality 2.7 (Tedimon 31 from Enichem S.p.A.), fed in at 20° C. and 150 bar, with an NCO/OH ratio equal to 2.5. The expanded product formed was immediately spread onto Kraft paper on a conveyor belt with an adjustable travelling speed kept constant at 3.6 m/min, with a distance between the bottom level and the top level of 110 mm.

The panels obtained, of excellent appearance, had the characteristics given in Table 2.

### EXAMPLE 3 (COMPARATIVE)

The process was performed as in Example 1, except that the liquid CO₂ was omitted and the amount of water was increased to 3.2% by weight.

The panels obtained, of excellent appearance, had the characteristics given in Table 3.

By comparing the examples, it is seen that the panel obtained by the process which is the subject of the present invention has an optimum density for use as a heat-insulating material in buildings. It also has dimensional stability characteristics that are comparable with those of the comparative panel, although having a lower density and improved fire resistance characteristics, making it possible to reduce the concentration of flame retardants.

TABLE 1

| | | Unit of | |
|---|---|---|---|
| Characteristic | Standard | measurement | Value |
| Core density | UNI EN | g/l | 34.5 |
| | ISO 845 | | |
| 10% compression strength | UNI 6350 | kg/cm² | 2.40 |
| Maximum compression strength | UNI 6350 | kg/cm² | 2.42 |
| Heat conductivity at 23° C. | UNI 7891 | W/m°K | 0.0232 |
| Fire reaction | DIN 4102 | | |
| Category | | | B2 |
| Maximum flame height | | cm | 5 |
| Dimensional stability | UNI 8069 | % | |
| at −25° C. for 7 | | | |
| days | | | |
| Variation in thickness | | | −0.19 |
| Variation in width | | | −0.05 |
| Variation in length | | | +0.03 |
| Dimensional stability at 70° C., | UNI 8069 | % | |
| 95% RH for 7 days | | | |
| Variation in thickness | | | +0.75 |
| Variation in width | | | +0.07 |
| Variation in length | | | −0.40 |

TABLE 2

| | | Unit of | |
|---|---|---|---|
| Characteristic | Standard | measurement | Value |
| Core density | UNI EN | g/l | 34.0 |
| | ISO 845 | | |
| 10% compression strength | UNI 6350 | kg/cm² | 2.35 |
| Maximum compression strength | UNI 6350 | kg/cm² | 2.38 |
| Heat conductivity at 23° C. | UNI 7891 | W/m°K | 0.0237 |
| Fire reaction | DIN 4102 | | |
| Category | | | B2 |
| Maximum flame height | | cm | 5.5 |
| Dimensional stability | UNI 8069 | % | |
| at −25° C. for 7 | | | |
| days | | | |
| Variation in thickness | | | −0.27 |
| Variation in width | | | +0.01 |
| Variation in length | | | −0.12 |
| Dimensional stability at 70° C., | UNI 8069 | % | |
| 95% RH for 7 days | | | |
| Variation in thickness | | | +0.60 |
| Variation in width | | | −0.24 |
| Variation in length | | | +0.12 |

TABLE 3

| | | Unit of | |
|---|---|---|---|
| Characteristic | Standard | measurement | Value |
| Core density | UNI EN | g/l | 43.7 |
| | ISO 845 | | |
| 10% compression strength | UNI 6350 | kg/cm² | 2.52 |
| Maximum compression strength | UNI 6350 | kg/cm² | 2.61 |
| Heat conductivity at 23° C. | UNI 7891 | W/m°K | 0.0235 |
| Fire reaction | DIN 4102 | | |
| Category | | | B2 |
| Maximum flame height | | cm | 7.5 |
| Dimensional stability | UNI 8069 | % | |
| at −25° C. for 7 | | | |
| days | | | |
| Variation in thickness | | | −0.08 |
| Variation in width | | | −0.03 |
| Variation in length | | | −0.13 |
| Dimensional stability at 70° C., | UNI 8069 | % | |
| 95% RH for 7 days | | | |
| Variation in thickness | | | +0.55 |
| Variation in width | | | +0.03 |
| Variation in length | | | −0.33 |

1. A process for producing a low-density rigid polyurethane foam which comprises reacting a polyisocyanate with a polyol composition which comprises a hydroxy-terminal polyfunctional polyol component in the presence of an expansion system comprising water, liquid CO₂ and optionally a hydrofluorocarbon auxiliary expander having from 1 to 6 carbon atoms, and in which the water is present in an amount of less than 1 part by weight per 100 parts of polyol component.

2. A process according to claim 1 in which the NCO/OH ratio is from 1.3 to 3.

3. A process according to any one of the preceding claims in which the polyisocyanate is selected from low molecular weight diisocyanates of general formual (I):
OCN—R—NCO (I)
in which r represents a C₅ to C₂₅ cycloaliphatic or C₆ to C₁₈ aromatic radical, optionally substituted in either case with a C₁ to C₄ alkyl radical.

4. A process according to any one of the preceding claims in which the polyisocyanate is selected from medium or high molecular weight polyisocyanates obtained by the phosgenation of an aniline-formaldehyde condensate the polyisocyanate having general formula (II): 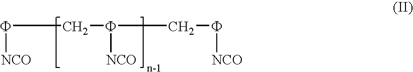
in which Φ represents a phenyl group and n is an integer greater than or equal to 1.

5. A process according to claim 4 in which the polyisocyanate has a functionality of between 2.6 and 2.9.

6. A process according to any one of the preceding claims in which the polyisocyanate is selected from multivalent modified polyisocyanates obtained by the partial chemical reaction of a diisocyanate and/or a polyisocyanate and containing biuret groups, allophanate groups, carbodiimide groups, isocyanurate groups and/or urethane groups.

7. A process according to any one of the preceding claims in which the polyol component comprises at least one polyol with a functionality of between 2 and 8 and an equivalent weight of between 50 and 500.

8. A process according to any one of the preceding claims in which the polyol is selected from polyether polyols, polyether polyols containing ester groups, polyether polyols containing amine groups, and polyester polyols.

9. A process according to any one of the preceding claims in which the polyol is selected from polyether polyols obtained by condensing a C₂ to C₆ olefinic oxide with a compound containing at least two active hydrogen atoms.

10. A process according to any one of the preceding claims in which the polyol is selected from polyester polyols obtained by the polycondensation of at least one dicarboxylic organic acid containing from 2 to 12 carbon atoms with at least one polyfunctional alcohol containing from 2 to 12 carbon atoms.

11. A process according to any one of the preceding claims in which water is present in an amount of less than 0.5 part by weight.

12. A process according to any one of the preceding claims, in which the liquid CO₂ is present at a level of 0.5% to 3% by weight of the polyol component.

13. A process according to claim 12 in which the liquid CO₂ is diluted in the polyol component.

14. A process according to any one of the preceding claims which comprises a hydrofluorocarbon auxiliary expander.

15. A process according to claim 14 in which the hydrofluorocarbon is selected from 1,1,1,2-tetrafluoroethane, 1,1,2,2-tetrafluoroethane, 1,1-difluoroethane, pentafluoroethane, 1,1,1,3,3-pentafluoropropane and 1,1,1,3,3-pentafluorobutane.

16. A process according to any one of claims 14 and 15 in which the hydrofluorocarbon auxiliary expander is 1,1,1,2-tetrafluoroethane, which is added in amounts of between 2.5% and 5% by weight relative to the polyol component.

17. A process according to any one of the preceding claims in which the expansion system comprises water, liquid CO₂ and a hydrofluorocarbon auxiliary expander having from 1 to 6 carbon atoms, in which the water is present in an amount of less than 1 part by weight per 100 parts of polyol component, CO₂ is present at a level of 0.5% to 3% by weight relative to the said polyol component and the hydrofluorocarbon auxiliary expander is present in a weight ratio with the CO₂ of 1 to 10.

18. A process according to any one of claims 1 to 13 in which the expansion system comprises water and liquid CO₂ in which the water is present in an amount of less than 1 part by weight per 100 parts of polyol component, CO₂ is present at a level of 0.5% to 3% by weight relative to the said polyol component and the expansion system is substantially free of hydrofluorocarbon compounds.

19. A rigid polyurethane foam obtainable by a process according to any one of the preceding claims having a density of 30 to 45 kg/m³ and comprising a fire retardant at a level of less than 25% by weight of the polyol component.

20. A process for producing a heat-insulating panel comprising a low-density rigid polyurethane foam obtainable by a process as defined in any one of claims 1 to 18.

21. A heat-insulating panel comprising low-density rigid polyurethane foam obtainable by a process as defined in claim 19 having a surface area of greater than one square meter and a thickness of between 2 and 20 cm.
